(19) United States
(12) Patent Application Publication
(10) Pub. No.: US 2016/0303572 A1
(43) Pub. Date: Oct. 20, 2016

(54) Adjustable Dwell Shredder

(71) Applicant: Riverside Engineering Inc., San Antonio, TX (US)

(72) Inventors: Randall R. Brace, San Antonio, TX (US); Dean Andersen, Greeley, CO (US)

(21) Appl. No.: 15/130,605

(22) Filed: Apr. 15, 2016

Related U.S. Application Data
(60) Provisional application No. 62/149,296, filed on Apr. 17, 2015.

(51) Int. Cl. B02C 13/282; B02C 13/286; B02C 13/10

(52) U.S. Cl. CPC B02C 13/282; B02C 13/10; B02C 13/286; B02C 2013/28636

(57) ABSTRACT

A system and method for liberating different materials in recyclable material streams is provided. A material stream is introduced into an adjustable dwell time shredder. The dwell time of the shredder is adjustable by rotating the shredder from a first position to a second position, thereby changing the migration rate of objects within the shredder. The liberation of materials is not dependent on the ability of the shredder to reduce materials to a certain granule size in order to pass through a grate or screen. The dwell time of the shredder may be adjusted during operation of the shredder.

### CROSS-REFERENCE TO RELATED APPLICATION

This patent application claims the benefit of U.S. Provisional Patent Application No. 62/149,296, filed Apr. 17, 2015, the entire teaching and disclosure of which is incorporated herein by reference thereto.

### FIELD OF THE INVENTION

This invention generally relates to systems and methods for improved mechanical separation and recovery of different types of materials from waste streams. More particularly, this invention relates to a hammermill-type shredder with an adjustable dwell time of materials in the shredder. The shredder provides an adjustable duration of mechanical processing, and an improved ability to liberate different material types from each other.

### BACKGROUND OF THE INVENTION

Processing of material streams for recycling requires separation of diverse, mechanically comingled types of materials. The automobile recycling process typically includes an automobile shredding process wherein vehicles and other scrap metals are pulverized into small pieces which are subsequently separated by type of material. For example, shredding automobiles for recycling produces a material stream containing various materials, including ferrous and non-ferrous metals, plastics, fiberglass, glass, wood, and rubber. Efficiently separated material streams can be sufficiently homogenous for recycling and reuse. For example, ferrous and non-ferrous metals are commonly recovered and reprocessed via scrap metal reprocessing. Typically, however, a portion of the materials cannot be sufficiently separated for recycling and reuse and, consequently, are disposed of in a landfill. Following an initial shredding and reduction of an automobile (or other bulk material sources such as household appliances), an additional, shredder or mill may be used to further separate materials into a convenient size for separation. A shredder may be employed to a non-separated material stream, or may be used to liberate various materials from each other after ferrous metals are magnetically removed from the material stream.

Hammermills have long been used for granulating mixed material streams. Large, hardened metal hammers are coupled to a rotary shaft and rotated at high speed against a cylindrical drum so that the hammers travel in a circular path. When a material stream containing large pieces of scrap, such as shredded automobiles or appliances, is fed into the hammermill, objects within the stream are repeatedly struck by the hammers in order to break off components and pulverized the objects into smaller pieces.

In a typical horizontal hammermill, the hammers are rotated on a horizontal shaft within a drum. The drum is provided with a screen or grate on a lower portion of the drum. As the hammers break individual pieces off objects within the drum, smaller pieces escape through the screen or grate, while remaining large pieces continue to be subjected to the hammering action until sufficiently reduced in size. In another type of hammermill, hammers are rotated on a vertical shaft within a drum. The drum is provided with a series of horizontal screens, with the screen mesh size decreasing from top to bottom of the hammermill. As materials are reduced in size, they migrate downwards until a minimum diameter is reached, when the granulated materials drop out of the hammermill. In both types of hammermills, however, the time an object remains inside the hammermill drum is determined principally by the ability of the hammers to break objects down into smaller component pieces capable of passing through the screen(s) or grate(s).

However, some objects may be highly resistant to further processing by a hammermill and will not pass through a screen or grate. Such unshreddable materials may increase wear to the hammermill, damage the hammermill, and/or require manual removal from the hammermill. Additionally, removing unshreddable materials from a hammermill may require taking the hammermill off-line, thereby decreasing the material stream throughput and increasing costs of operation. Additionally, screens or grates, although generally made of hardened metals, are subject to mechanical deformation from the repeated forces imparted by the rotary hammers, transmitted through objects within the hammermill.

### BRIEF SUMMARY OF THE INVENTION

The present invention is generally directed towards a rotary hammermill material shredder having an adjustable dwell time. The adjustable dwell shredder may be operated with its axis of rotation horizontal, or the axis of rotation may be adjustable tilted off of horizontal. Unlike a conventional hammermill, the adjustable dwell hammermill of the present invention does not require screen or grates to process material streams.

In one aspect, the invention provides for an adjustable dwell time shredder. The shredder comprises a frame and a generally planar support platform. The support platform is rotatably coupled to the frame, and can be rotated between a first position and a second position. A rotary hammermill coupled to the support platform. The rotary hammermill includes a rotatable shaft, a plurality of hammers coupled to the shaft; and a cylindrical drum. The cylindrical drum has a feed end and an outlet end opposite the feed end. The cylindrical drum also includes a feed opening proximate to the feed end, and an outlet opening proximate to the outlet end. The hammermill has a first dwell time when the support platform is in the first position, and a second dwell time when the support platform is in the second position.

In another embodiment, the invention provides a method of shredding a material stream. The steps include providing support platform which is rotatable between a first position and a second position, and providing a hammermill shredder coupled to the rotatable support platform. The hammermill shredder includes a feed opening and an outlet opening. The steps also include positioning the support platform in one of the first position or the second position to select the dwell time of the hammermill shredder, introducing a material stream at a feed opening of the hammermill shredder, and collecting a separated material stream at an outlet opening of the hammermill shredder.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of an adjustable dwell time shredder of the present invention, showing the shredder in a first horizontal position;

FIG. 2 is a side view of an adjustable dwell time shredder of the present invention, showing the shredder in a second position at an angle to horizontal;

FIG. 3 is an isometric view of an adjustable dwell time shredder of the present invention, showing the shredder in a first horizontal position;

FIG. 4 is a detail cross-sectional view of an adjustable dwell time shredder of the present invention;

FIG. 5 is a detail top view of a hammermill and tilting platform of an adjustable dwell time shredder of the present invention;

FIG. 6 is a cross-sectional view of a hammermill and tilting platform of an adjustable dwell time shredder of the present invention

FIG. 7 is a further detail cross-sectional view of an adjustable dwell time shredder of the present invention; and

FIG. 8 is a detail side view of a bearing assembly suitable for used with adjustable dwell time shredder of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

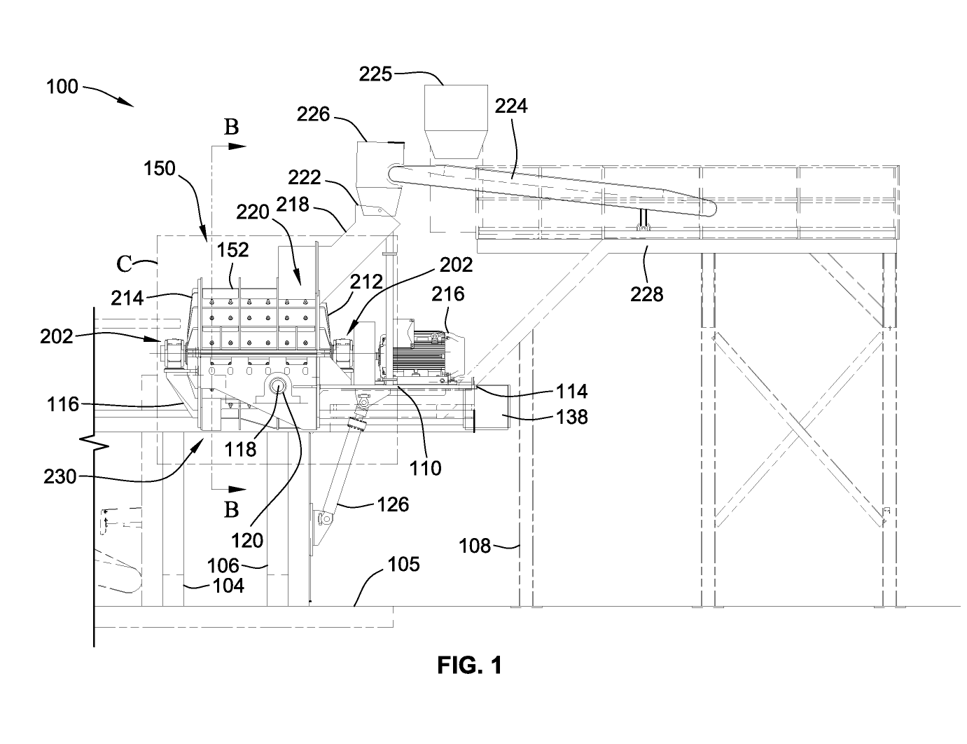

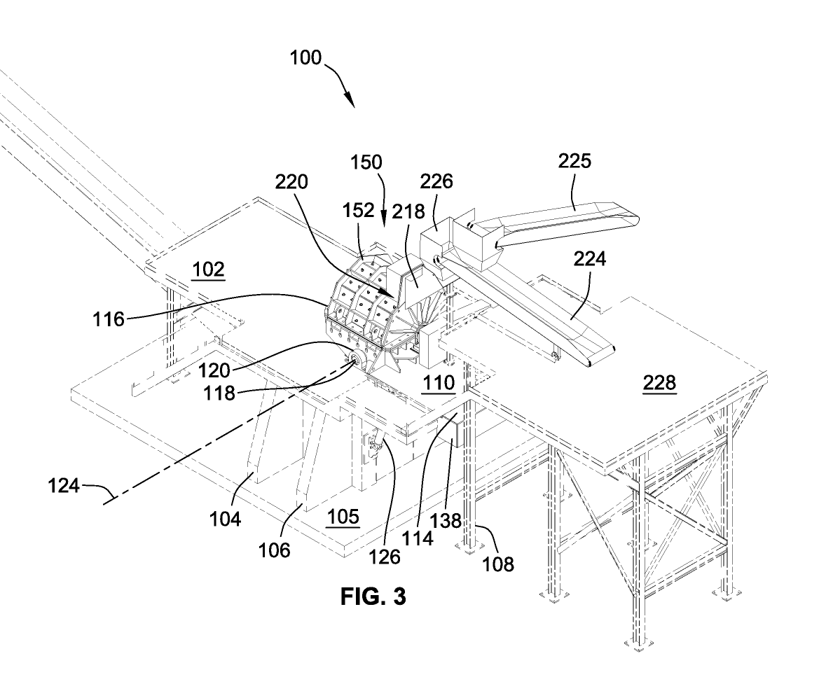

The present invention provides an adjustable dwell time shredder having a material dwell time that is adjustable by rotation of the shredder from a first position to a second position. Referring to FIGS. 1-3, an adjustable dwell time shredder system 100 is shown. Shredder system 100 includes a generally planar stationary platform 102, a tilting platform 110, and a shredder 150. Stationary platform 102 is generally horizontal and allows access to components of shredder system 100 for service and repair. Stationary platform 102 is typically supported by a frame 104 above the ground 105. Frame 104 may be constructed of any structural material generally known in the art, such as iron, steel, concrete, wood, or a combination thereof. As shown, frame 104 includes both concrete pillars 106 and metal framework 108.

Shredder system 100 further includes a tilting framework or platform 110. As shown, tilting platform 110 is generally planar and rectangular having sides 112, first end 114, and second end 116. The general shape of tilting platform 110 may be varied as required to support additional components of shredding system 100 mounted on tilting platform 110, as discussed in further detail below. In a preferred embodiment, tilting platform 110 is provided with trunnions 118 protruding horizontally from sides 112 of tilting platform 110. Trunnions 118 are rotatably coupled to trunnions bearings 120 of stationary platform 102. Preferably, trunnions 118 are located at or near the center of mass 122 of tilting platform 110 between first end 114 and second end 116. In the embodiment shown, trunnions 118 are offset from the center of mass in the direction of second end 116. In other embodiments, trunnions 118 may be offset from the center of mass 122 in the direction of first end Tilting platform 110 is thereby rotatably coupled to stationary platform 102 about axis of rotation 124.

Rotation of platform 110 may be accomplished by any means known in the art. In the embodiment shown, a hydraulic cylinder 126 is coupled between frame 104 and tilting platform 110 to rotate tilting platform 110 about axis of rotation 124. Cylinder barrel 128 of hydraulic cylinder 126 is coupled to frame 104 at frame coupling 130, which may include a clevis and pin, or another rotatable coupling. Piston rod 132 of hydraulic cylinder 126 is coupled to tilting platform 110 at platform coupling 134, which may also include a clevis and pin, or another rotatable coupling. Where trunnions 118 are offset from the center of mass 122 in the direction of second end 116, platform coupling 134 is typically coupled to tilting platform 110 at a location between center of mass 122 and first end 114. Hydraulic cylinder 126 may be operated (i.e., extended or contracted) during operation of rotary shredder 150.

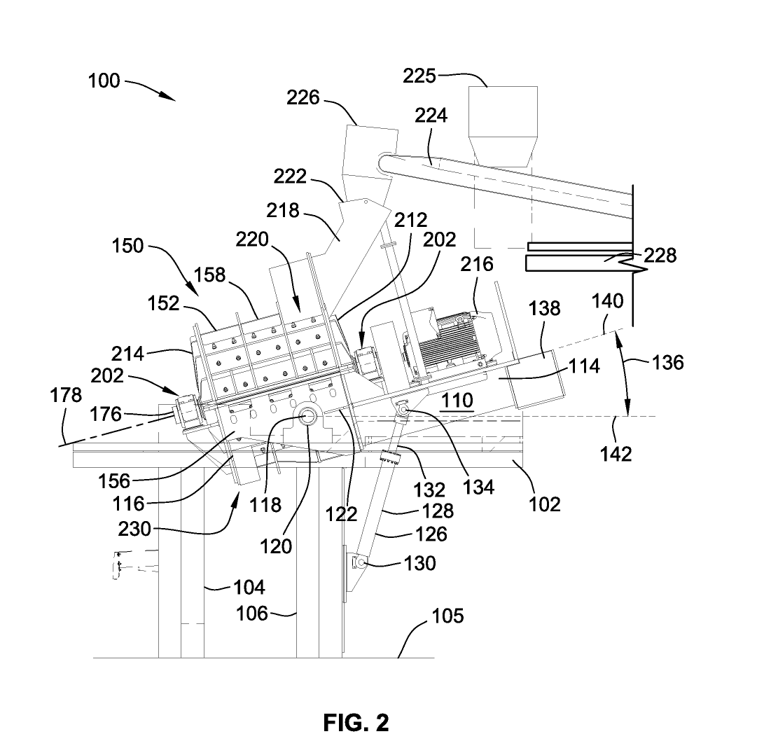

As shown in FIG. 2, actuation of hydraulic cylinder 126 extends piston rod 132 with respect to barrel 128, thereby rotating tilting platform 110 around axis of rotation 124. As hydraulic cylinder 126 is extended, first end 114 is elevated with respect to horizontal plane 142, while second end 116 is lowered with respect to horizontal plane 142. In a preferred embodiment, hydraulic cylinder 126 is a double-acting hydraulic cylinder capable of exerting a force in both extension and retraction. In another embodiment, hydraulic cylinder 126 is a single-acting hydraulic cylinder, and a separate hydraulic cylinder may be provided to rotate tilting platform 110 towards a horizontal position. As will be generally recognized by those skilled in the art, other configurations of tilting platform 110, trunnions 118 and trunnions bearings 120 of stationary platform 102, and hydraulic cylinder 126 may be employed to tilt the tilting platform 110 away from horizontal. For example, barrel end 130 of hydraulic cylinder 126 may instead be coupled to the ground 105. In another example, barrel end 130 and rod end 134 may be reversed.

A tilt angle 136 is shown between a plane 140 of tilting platform 110 and a horizontal plane 142. In a preferred embodiment, tilting platform 110 may be rotatable from horizontal to a tilt angle 136 of 0 to 15 degrees. In a more preferred embodiment, tilting platform 110 may be rotatable from horizontal to a tilt angle 136 of 45 degrees or more. In a still more preferred embodiment, tilting platform 110 may be rotatable from horizontal to a tilt angle 136 of 60 degrees or more. In some embodiments, tilting platform 110 may also be rotatable to a negative tilt angle 136, for example at least −5 degree or negative 10 degrees. A tilt sensor may be provided to indicate the tilt angle of tilting platform 110 and provide feedback to an operator for dynamic control of the tilt angle during shredding operations.

To facilitate balancing of tilting platform 110 as additional equipment is mounted to the platform 110, one or more adjustable or non-adjustable counterweights 138 may be provided. In the embodiment shown in FIGS. 1-3, a counterweight 138 is shown at first end 114 of tilting platform 110. Counterweight 138 includes a concrete weight that may be added to tilting platform 110 after assembly of shredding system 100. In another embodiment, counterweight 138 may be a hollow structure suitable for retaining an adjustable quantity of water. In still another embodiment, counterweight 138 may include a support rail or bracket suitable for attachment of metal weights, for example tractor weights.

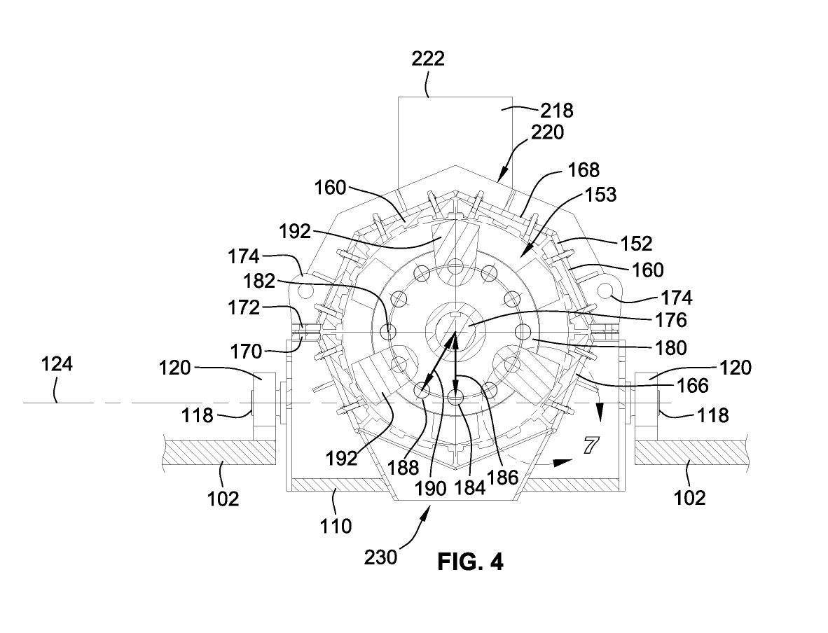

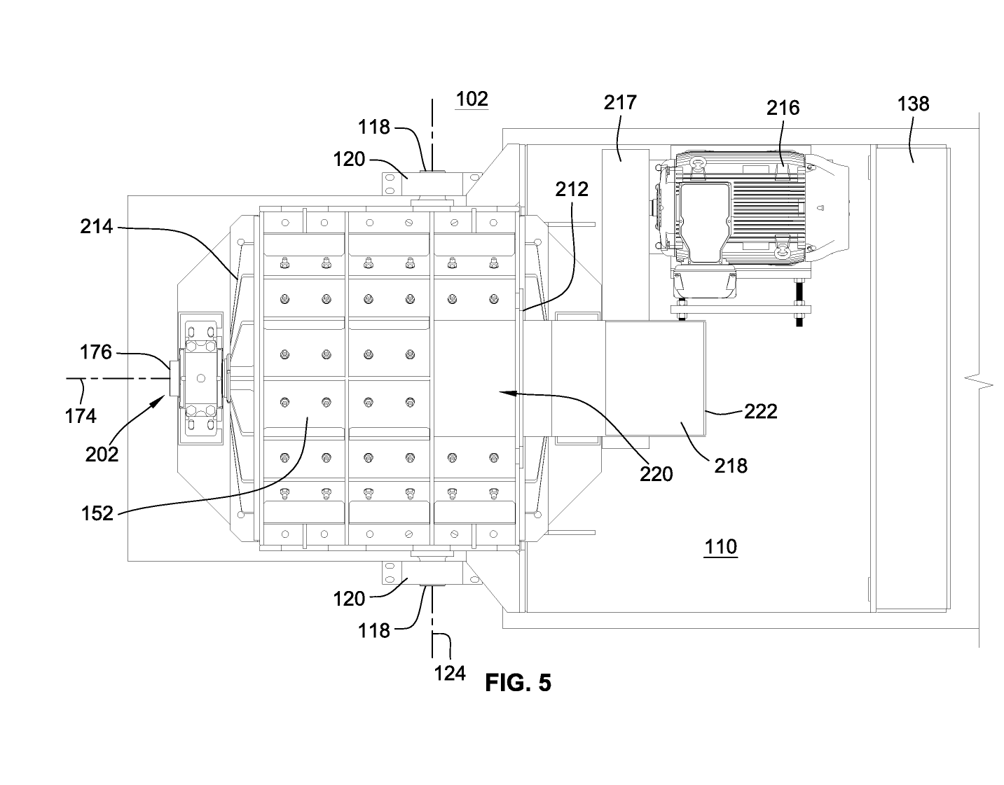

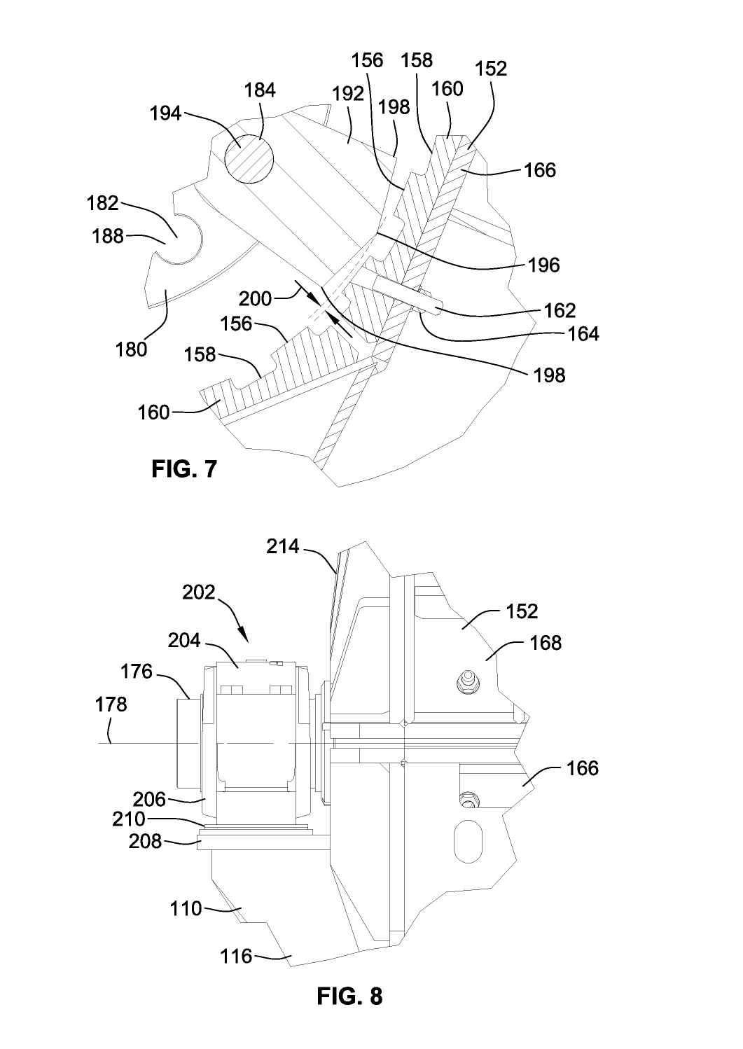

Referring to FIGS. 4-7, a hammermill-type rotary shredder 150 is mounted on tilting platform 110. Rotary shredder 150 includes a generally polygonal or cylindrical drum wall 152 defining an inner cavity 153. Inner cavity 153 of drum wall 152 is further provided with a ribbed inner liner 154. As best shown in detail FIG. 7, ribbed inner liner 154 includes alternating peaks 156 and valleys 158. As shown, peaks 156 and valleys 158 are alternating, generally planar surfaces with longitudinal axes generally parallel to shaft 176. On other embodiments, peaks 156 and valleys 158 may have other profiles, such as a sawtooth profile, rounded corrugations, and the like. In still other embodiments, the longitudinal axes of peaks 156 and valleys 158 may be angled with respect to the axis of shaft 178, that is, they may describe a helical path within inner cavity 153 of drum 152. In still other embodiments, a patterned arrangement of peaks 156 and valleys 158 may be provided. In a preferred embodiment, ribbed inner liner 154 is typically formed from inner liners segments 160. As best shown in FIG. 7, inner liner segments may be removably secured to drum wall 152, for example by bolts 162 and nuts 164. As inner liner segments 160 become worn due to abrasion by materials being processed, liner segments 160 may be replaced to improve the performance of shredder 150.

In a typical embodiment, drum wall 154 is formed from at least two segments, shown as lower drum wall 166 and upper drum wall 168. Lower drum wall 166 may be mounted on tilting platform 110. Alternatively, lower drum wall 166 may be integrally formed with tilting platform 110. As shown, lower drum wall 166 includes generally horizontal lower flanges 170 extending radially outward from the center of shredder 150. Upper drum wall 168 further includes generally horizontal upper flanges 172 extending radially outward from the center of shredder 150. Lower and upper flanges 170, 172 may be removably coupled together such that lower drum wall 166 and upper drum wall 168 form generally cylindrical drum wall 154. Upper drum wall 168 may also be provided with lift points 174, whereby upper drum wall 168 may be lifted off of lower drum wall 166 and tilting platform 110 to allow access to inner cavity 153 of shredder 150, for example to repair or replace interior components of drum shredder 150.

Shredder 150 also includes a central shaft 176 having a rotor centerline 178. Shaft 176 may be reversibly rotated around rotor axis 178. A plurality of rotor plates 180 are spaced along the shaft. Rotor plates 180 are generally circular and include spaced hammer rod holes 182. In some embodiments, hammer rod holes 182 include a first set of hammer rod holes 184 spaced at a first radial distance 186 from rotor centerline 178, and a second set of hammer rod holes 188 spaced at a second radial distance 190 from rotor centerline 178. In the embodiment shown, hammer rod holes 182 in the first set 184 are circumferentially alternated with hammer rod holes of the second 188. Hammer rod holes 182 may also include a replaceable bushing surface. Hammers 192 are coupled to rotor plates 180 via hammer rods 194. In a typical embodiment, a plurality of hammers 192 are coupled to rotor plates 180 in a symmetrical arrangement to ensure that shaft 176 is balanced during rotation. Hammer rods 194 may also be permitted to rotate within hammer rod holes 182, thereby permitting hammers 192 to rotate with respect to rotor plate 180. As hammers 192 wear, hammers 192 may be repositioned from attachment to rotor 180 at the first set of hammer rod holes 184 to attachment at the second set of hammer rod holes 188, thereby decreasing the gap 200 (best shown in FIG. 7) between hammer tips 196 and peaks 156 of inner liner segments 160.

During rotation of shaft 176, rotor plates 180, and hammers 192 within inner cavity 153, the action of the hammers 192 breaks down objects placed within inner cavity 153 by subjecting the objects to impacts between inner ribbed liner 154 and hammers 192, including both tip 196 and corners 198 of hammers 192. In a typical embodiment suitable for processing shredded automotive material streams, tips 196 of hammers 192 are spaced from peaks 156 of inner liner 154 by about 1/2 inch during rotation of rotation of shaft 176, rotor plates 180, and hammers 192, shown as spacing 200. Although materials are recirculated throughout inner cavity 153 by the rotating of hammers 192, it is anticipated that most of the operative granulation of objects will occur in the lower drum 166. In such an environment, wear of the hammers 192 and liner 154 will gradually increase spacing 200, particularly in portion of inner cavity 153 proximate to lower drum wall 166. The increase of spacing 200 gradually reduces the efficiency of shredder 150 and necessitates periodic replacement of inner liner segments 160, hammers 192, or both.

Referring to FIG. 8, a shaft bearing assembly 202 is shown. In this embodiment, cylindrical drum 152 and shaft 178 are each independently supported by platform 110 such that shaft 174 and associated components can rotate freely within inner cavity 153 of drum 152. Shaft bearing assembly 202 includes a housing 204 and a bearing race 206. Bearing race 206 supports internal roller bears (not shown) rotatably supporting shaft 178. Bearing housing 204 and shaft 174 are supported by a shaft bracket 208 of platform 110. One or more shims 210 are interposed between bearing housing 204 and shaft bracket 208. As described above, operation of shredder 150 is expected to cause wear of liner 154 proximate to the bottom of drum 152. Accordingly, as spacing 200 increases proximate to the bottom of drum 152, one or more shims 210 can be removed from underneath the bearing assemblies 204 positioned at ends 212, 214 of drum 152. Removal of shims 210 lowers the height of shaft 176 with respect to platform 110 and the centerline of drum 152, thereby lowering reducing the spacing 200 between hammers 192 and drum 152 proximate to the bottom of drum 152. Adjusting spacing 200 thereby permits increased operational time between replacement of liner segments 160 of inner liner 154, reducing non-operational time of shredder system 100 and lowering operation costs.

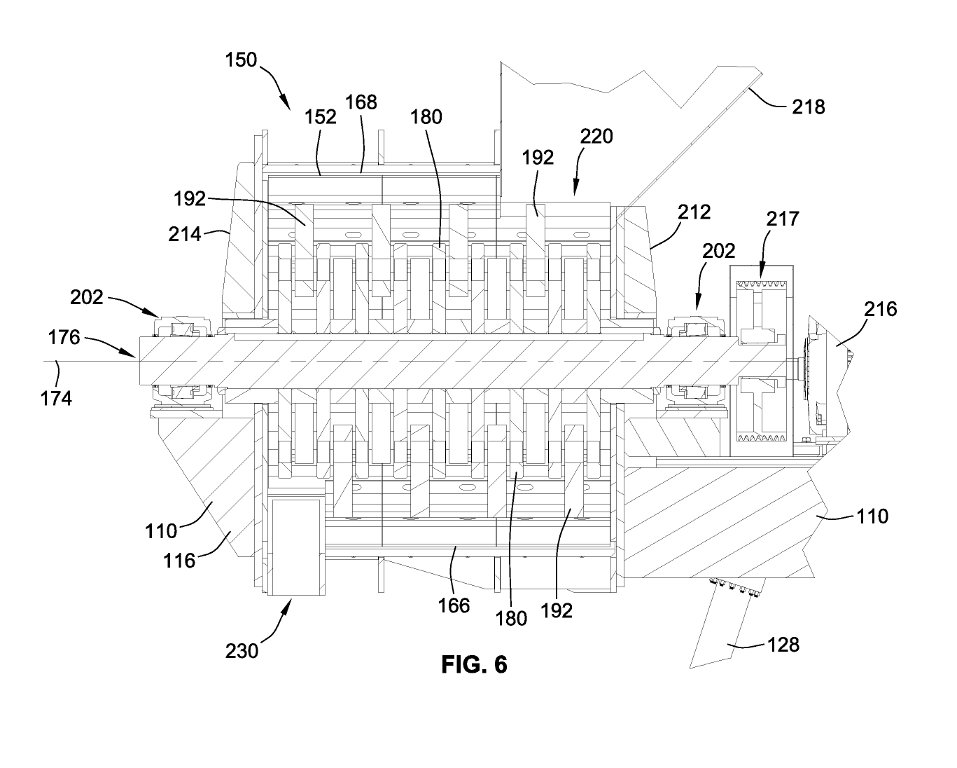

As best shown in FIGS. 2 and 6, a bearing assembly 202 is provided at each end 212, 214 of drum 152. Additionally, an engine or motor 216 is coupled to shaft 174 to rotate shaft 174 within drum 152. In a preferred embodiment, motor 216 is an electric motor of between about 400 to 700 horsepower. Motor 216 is preferably reversible to allow shaft 174 and associated components to rotate in either direction. Furthermore, motor 216 is preferably operable to rotate shaft 174 at a rotation speed between about 450 to 900 revolutions per minute. Motor 216 may drive shaft 174 directly or indirectly, as is generally known in the art. In a preferred embodiment, motor 216 is supported by platform 110 and is coupled to shaft 174 by a belt 217. In some embodiments, two or more motors 216 may be coupled to the shaft 174.

Rotary shredder 150 further includes a feed chute 218. Feed chute 218 is coupled to feed opening 220 in the upper wall 168 of drum 152. Feed opening 220 is located proximate to feed end 212 of drum 152, and top end 222 of feed chute 218 is positioned to receive a material stream from a material source, shown as horizontal conveyor belt 224 and bucket 226 positioned on upper platform 228. Conveyor 224 receives a material stream from a stationary source 225, which may be, for example, the output of an upstream shredder or another conveyor belt. Bucket 226 is positioned in feed alignment with top end 222 of feed chute 218, such that a material stream exiting feed bucket 226 of conveyor 224 falls and slides into feed opening 220.

Rotation of platform 110 from a first position, for example a generally horizontal position as shown in FIG. 1, to a second position, for example a tilted position as shown in FIG. 2, causes translation of top end 222 of feed chute 218. In the embodiment show, conveyor belt 224 and bucket 226 may be translated in a generally horizontal direction on upper platform 228. During rotation of tilting platform 110, bucket 226 of feed conveyor 224 is thereby translated from a third position to a fourth position to maintain bucket 226 in feed alignment with top end 222, thereby providing an uninterrupted material stream to shredder 150 when platform 110 is rotate from a first position to a second position.

Rotary shredder 150 further includes an outlet opening 230 in lower wall 156, proximate to outlet end 214 of drum 152. Outlet opening 230 is sized such that it does not limit the ability of objects in a material stream to exit drum 152 depending on size. That is, outlet opening 152 is not provided with a screen, grate, or other size-based restriction to retain objects introduced to shredder 150 and capable of migrating from feed end 212 to outlet end 214. Furthermore, bottom wall 166 of drum 152 typically does not have openings in liberation zone 167. Outlet opening 230 is typically placed above a collection bin, additional conveyor, etc., for transferring granulated and liberated materials to another location for additional processing and/or separation.

In operation, materials introduced into drum 152 at feed opening 220 migrate from feed end 212 to outlet end 214 during random interactions with hammers 192 and inner liner 154. The time required for objects to migrate to the outlet opening 230 of drum 152 may be referred to as the dwell time of the shredder. The dwell time can be controlled by adjusting the tilt angle 136 of the platform 110 with respect to horizontal. When drum 152 is horizontal, the gravitational force exerted on objects within the drum 152 is perpendicular to the plane tangent to the bottom of the drum 152, and objects within the shredder are not urged towards opening 230 by gravity. As tilt angle 136 is increased such that drum 152 is not horizontal, for example the drum position of FIG. 2 relative to the drum position of FIG. 1, gravity exerts a force on objects within the shredder having a force vector component in the direction of opening 230, thereby urging objects within the shredder towards opening 230. As objects within the shredder are additionally urged towards opening 230 by both interactions with rotating hammers 192 and the force of gravity, the dwell time of objects within the drum 152 is reduced relative to the dwell time when the drum 152 is in a horizontal orientation. By adjusting the length of hydraulic cylinder 126 during operation of rotary shredder 150, the dwell time of objects within the drum 152 may be dynamically adjusted or controlled during shredding operations.

In contrast to a conventional horizontal or vertical shredder, dwell time is not dependent on the ability of the shredder to reduce objects to a certain size and thereby permit the objects to pass through a grate or screen. Accordingly, even unshreddable materials will be urged towards outlet end 214 and outlet opening 230 and will drop out of the shredder, in contrast to an unshreddable material that cannot effectively be reduced in size to fit through the screen or grate of a conventional horizontal or vertical shredder.

Furthermore, providing an adjustable dwell time permits liberation of different material types from each other without requiring shredding below a pre-defined granule size to exit the shredder. For example, non-ferrous metals of a wiring harness may be effectively liberated from non-metal components (e.g., plugs, mounting brackets, and the like) without simultaneously requiring that the copper wiring be reduced below a specific granule size to terminate shredding. Accordingly, the adjustable dwell time shredder of the present invention may be particularly suitable for liberating different material types in non-ferrous automotive shredding residue (ASR) streams.

In a preferred embodiment, ribbed inner liner 154 does not include screen or grate openings at in lower wall 166 to allow materials below an effective diameter to drop out of rotary shredder 150. However, the shredder of the present invention may further include conventional screen or grate openings at the bottom of lower drum wall 166 at locations different from the location of outlet opening 230, for example in liberation zone 167, thereby combining the ability to remove shredded materials below a certain effective diameter with an adjustable dwell time for materials having a larger effective diameter.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An adjustable dwell time shredder comprising:
a frame;
a generally planar support platform, wherein the support platform is rotatably coupled to the frame and rotatable between a first position and a second position; and
a rotary hammermill coupled to the support platform, the rotary hammermill comprising:
a rotatable shaft;
a plurality of hammers coupled to the shaft; and
a cylindrical drum having a feed end and an outlet end opposite the feed end, a feed opening proximate to the feed end, and an outlet opening proximate to the outlet end,
wherein the hammermill has a first dwell time when the support platform is in the first position, and a second dwell time when the support platform is in the second position.

2. The shredder of claim 1, wherein the plane of the support platform is generally horizontal when the support platform is in the first position.

3. The shredder of claim 2, wherein the plane of the support platform is at an angle to horizontal when the support platform is in the second position.

4. The shredder of claim 1, wherein the shredder further comprises a feed material conveyor having a feed conveyer outflow, wherein the feed conveyor outflow is translatable between a third position in feed alignment with the feed opening when the support platform is in the first position and a fourth position in feed alignment with the feed opening when the support platform is in the second position.

5. The shredder of claim 1, wherein the shredder further comprises a hydraulic cylinder having a first end and a second end, the first end coupled to the frame and the second end coupled to the support platform, wherein the hydraulic cylinder is operable to move the support platform between the first position and the second position.

6. The shredder of claim 1, wherein the outlet opening does not include a screen or grate.

7. The shredder of claim 1, further comprising a screen or grate at a location in the cylindrical drum distinct from the outlet opening.

8. The shredder of claim 3, wherein the plane of the support platform is at a tilt angle of between 5 degrees to 60 degrees to horizontal when the support platform is in the second position.

9. The shredder of claim 3, wherein the plane of the support platform is at a tilt angle of greater than 60 degrees to horizontal when the support platform is in the second position.

10. A method of shredding a material stream comprising the steps of:
providing support platform, the support platform rotatable between a first position and a second position;
providing a hammermill shredder coupled to the rotatable support platform, the hammermill shredder including a feed opening and an outlet opening;
positioning the support platform in one of the first position or the second position to select the dwell time of the hammermill shredder;
introducing a material stream at a feed opening of the hammermill shredder; and
collecting a separated material stream at an outlet opening of the hammermill shredder.

11. The method of claim 10, wherein the outlet opening does not include a screen or grate.

12. The method of claim 8, wherein the support platform is generally horizontal when the support platform is in the first position.

13. The method of claim 8, wherein the support platform is at a tilt angle of between about 5 degrees to 60 degrees to horizontal when the support platform is in the second position.

14. The method of claim 8, further comprising the step of rotating the support platform between the first position and second position during shredding.

15. The method of claim 8, further comprising the steps of providing a feed conveyer, and placing the feed conveyor in a first feed position when the support platform is in the first position.

16. The method of claim 15, further comprising the step of placing the feed conveyor in a second feed position when the support platform is in the second position.

17. An adjustable dwell time shredder comprising:
a frame;
a support platform, wherein the support platform is rotatably coupled to the frame and rotatable between a first position and a second position; and
a rotary hammermill coupled to the support platform, the rotary hammermill comprising:
a rotatable shaft;
a plurality of hammers coupled to the shaft; and
a drum having a feed end and an outlet end opposite the feed end, a feed opening proximate to the feed end, and an outlet opening proximate to the outlet end,
wherein a gravitational force is exerted on objects within the drum, the gravitational force being perpendicular to the bottom of the drum when the platform is in the first position, and the gravitational force being non-perpendicular to the bottom of the drum when the platform is in the second position.

18. The shredder of claim 17, wherein the shredder further comprises a feed material conveyor having a feed conveyer outflow, wherein the feed conveyor outflow is translatable between a third position in feed alignment with the feed opening when the support platform is in the first position and a fourth position in feed alignment with the feed opening when the support platform is in the second position.

19. The shredder of claim 17, wherein the shredder further comprises a hydraulic cylinder having a first end and a second end, the first end coupled to the frame and the second end coupled to the support platform, wherein the hydraulic cylinder is operable to move the support platform between the first position and the second position.

20. The shredder of claim 17, wherein the outlet opening does not include a screen or grate.
